(19) United States
(12) Patent Application Publication
(10) Pub. No.: US 2026/0348572 A1
(43) Pub. Date: Nov. 5, 2026

(54) LIGHTING APPARATUS

(71) Applicant: LEEDARSON LIGHTING CO.,LTD., Zhangzhou, Fujian (CN)

(72) Inventors: Yongliang Zhang, Zhangzhou, Fujian (CN); Hongbin Lin, Zhangzhou, Fujian (CN)

(21) Appl. No.: 18/774,887

(22) Filed: Jul. 16, 2024

(30) Foreign Application Priority Data
Jul. 17, 2023 (CN) 202321877230.7

(51) Int. Cl. F21V 23/04; F21K 9/232; F21K 9/238; F21K 9/66; F21V 23/00; F21Y 105/10; F21Y 115/10

(52) U.S. Cl. CPC F21V 23/0485; F21K 9/232; F21K 9/238; F21K 9/66; F21V 23/002; F21V 23/006; F21V 23/009; F21Y 2105/10; F21Y 2115/10

(57) ABSTRACT

A lighting apparatus includes multiple LED modules, a light source plate, a driver circuit, a driver plate, a flexible flat cable, a bottom housing, a top housing and an Edison cap. The multiple LED modules are disposed on a front side of the light source plate. The driver circuit is disposed on the driver plate. The flexible flat cable has a maximum length. The flexible flat cable has a first end connected to the light source plate and has a second end connected to the driver plate. The bottom housing is for disposing the driver plate. The top housing encloses the light source plate and the multiple LED modules. The top housing is manually operated to adjust a relative distance between the top housing and the bottom housing along a longitudinal direction to alter a total combined length in the longitudinal direction.

### FIELD

The present invention is related to a lighting apparatus, and more particularly related to a lighting apparatus with a adjustable structure.

### BACKGROUND

LED (Light Emitting Diode) technology has undergone significant development since its inception in the early 20th century. The first practical LED was developed in 1962 by Nick Holonyak Jr., a scientist at General Electric. Initially, LEDs were limited to emitting low-intensity red light and were used primarily as indicator lights in electronic devices. These early LEDs were inefficient and expensive, which restricted their applications. However, the fundamental principle of electroluminescence, where materials emit light in response to an electric current, laid the groundwork for future advancements.

Throughout the 1970s and 1980s, improvements in materials and manufacturing techniques led to the development of LEDs that could emit light in different colors, including green and yellow. These advancements were driven by the discovery and utilization of new semiconductor materials like gallium phosphide and gallium arsenide. Concurrently, researchers worked on enhancing the efficiency and brightness of LEDs, making them more suitable for practical applications. By the late 1980s, LEDs were being used in digital displays, traffic lights, and signage, though they were still not efficient enough for widespread lighting applications.

The breakthrough that revolutionized LED technology came in the 1990s with the development of blue LEDs by Shuji Nakamura and his colleagues. Using gallium nitride (GaN) and indium gallium nitride (InGaN) as the semiconductor materials, they were able to create high-brightness blue LEDs. This innovation was crucial because it enabled the creation of white light LEDs by combining blue LEDs with phosphors that convert blue light to white light. This breakthrough not only expanded the range of applications for LEDs but also paved the way for their use in general lighting.

As the 21st century progressed, LED technology continued to evolve rapidly. Advances in materials science, particularly the development of more efficient phosphors and quantum dot technologies, have significantly improved the color rendering and efficiency of LEDs. Additionally, improvements in manufacturing processes, such as the development of epitaxial growth techniques and surface coating technologies, have reduced production costs and increased the durability of LEDs. These enhancements have made LEDs the preferred choice for a wide range of applications, from residential and commercial lighting to automotive and outdoor lighting.

Today, LED technology is at the forefront of the lighting industry, driven by its energy efficiency, long lifespan, and versatility. LEDs consume significantly less energy compared to traditional incandescent and fluorescent bulbs, resulting in lower electricity bills and reduced environmental impact. Their long operational life, often exceeding 50,000 hours, reduces the need for frequent replacements, further contributing to their cost-effectiveness and sustainability. The versatility of LEDs allows for innovative lighting solutions, including smart lighting systems that can be controlled remotely and integrated into smart home ecosystems.

Looking ahead, the future of LED technology is promising, with ongoing research focusing on enhancing efficiency, reducing costs, and expanding applications. Emerging technologies such as organic LEDs (OLEDs) and micro-LEDs are poised to further transform the lighting and display industries. OLEDs, known for their flexibility and ability to produce high-quality, vibrant displays, are being used in advanced televisions and smartphones. Micro-LEDs, with their potential for higher brightness and energy efficiency, are expected to revolutionize display technology. As LED technology continues to evolve, it will play a crucial role in addressing global challenges related to energy consumption and sustainability.

Due to its numerous advantages, LED technology is rapidly replacing traditional light sources such as incandescent and fluorescent bulbs. One of the key features driving this replacement is energy efficiency. LEDs use significantly less electricity to produce the same amount of light as traditional bulbs, which translates to substantial energy savings. This efficiency is particularly important in large-scale applications, such as street lighting and commercial buildings, where the cumulative energy savings can be immense. Additionally, LEDs generate very little heat compared to incandescent bulbs, which convert much of their energy into heat rather than light. This not only makes LEDs safer and cooler to touch but also reduces the load on air conditioning systems, leading to further energy savings.

Another crucial feature of LED technology is its long lifespan. LEDs can last up to 25 times longer than traditional incandescent bulbs and about three to five times longer than compact fluorescent lamps (CFLs). This extended lifespan significantly reduces maintenance costs and the frequency of replacements. For businesses and municipalities, this means fewer disruptions and lower labor costs associated with changing bulbs. In residential settings, it translates to convenience and cost savings for homeowners. The long life of LEDs also contributes to environmental sustainability by reducing the number of bulbs that end up in landfills.

LEDs offer unparalleled versatility and design flexibility, which has expanded their use in a wide variety of lighting devices. Their small size and ability to be integrated into compact and innovative designs make them ideal for applications where traditional bulbs would be impractical. For example, LEDs are extensively used in automotive lighting, including headlights, tail lights, and interior lights, due to their durability, energy efficiency, and ability to produce bright, focused light. In the entertainment industry, LEDs are used in stage lighting, displays, and screens, offering vibrant colors and dynamic lighting effects that enhance performances and visual experiences.

In the realm of smart lighting, LEDs are a natural fit due to their compatibility with digital controls. Smart LED bulbs can be controlled remotely via smartphones or integrated into smart home systems, allowing users to adjust brightness, color, and timing according to their preferences. This capability not only adds convenience and customization but also contributes to energy efficiency through features like automatic dimming and motion detection. Moreover, the ability to control LED lighting remotely and programmatically makes them ideal for applications in smart cities, where streetlights and public lighting can be managed centrally to optimize energy use and maintenance schedules.

The environmental benefits of LED technology extend beyond energy efficiency and long lifespan. LEDs are free of hazardous materials such as mercury, which is present in fluorescent bulbs, making them safer for both users and the environment. Their reduced energy consumption means lower greenhouse gas emissions from power plants, contributing to efforts to combat climate change. Additionally, the development of recycling programs specifically for LEDs is making it easier to dispose of them responsibly, further minimizing their environmental impact.

Overall, the features of LED technology—energy efficiency, long lifespan, versatility, and environmental friendliness—have made them the preferred choice for a wide range of lighting applications. From residential homes to commercial buildings, public infrastructure to personal devices, LEDs are becoming ubiquitous. As technology continues to advance, the integration of LEDs into various lighting devices and systems will only increase, driving further innovations and benefits. This widespread adoption of LED technology marks a significant shift in the lighting industry, promising a more sustainable and efficient future.

LED panel lights have become increasingly popular in a variety of settings, including restaurants, living rooms, and commercial environments, due to their ability to provide soft, even lighting. These fixtures consist of an array of LEDs mounted on a flat panel that diffuses the light, creating a smooth and uniform glow that reduces glare and shadows. This quality of light is particularly desirable in spaces where comfort and ambiance are important, such as dining areas and living spaces. In commercial environments, the consistent and high-quality light from LED panels enhances visibility and productivity while maintaining a pleasing aesthetic.

One of the standout features of LED panel lights is their sleek, low-profile design, which allows them to be seamlessly integrated into ceilings and walls. This modern look is not only visually appealing but also saves space and makes the fixtures less obtrusive. The slim design of LED panel lights is ideal for environments with low ceilings or where a minimalist appearance is desired. Additionally, these lights often come in various shapes and sizes, offering flexibility in design and installation to suit different architectural styles and spatial requirements.

Despite the advantages of LED panel lights, there is a growing demand for even more flexible configurations to meet diverse lighting needs. People are increasingly looking for lighting solutions that can be customized and adjusted to fit their specific preferences and requirements. This has led to the development of panel lights with adjustable color temperatures and brightness levels. By incorporating tunable white technology, users can change the color temperature from warm to cool white, adapting the lighting to different activities and times of day. Dimmable options allow for control over light intensity, providing the right amount of light for any setting or mood.

In addition to adjustable lighting, smart technology is playing a significant role in enhancing the flexibility of LED panel lights. Smart panel lights can be controlled via remote controls, smartphone apps, or integrated into smart home systems. This allows users to create and save different lighting scenes, set schedules, and even automate lighting based on occupancy or natural light levels. In commercial environments, smart controls can optimize energy usage and enhance the lighting experience for employees and customers alike. For instance, in a restaurant, different lighting scenes can be programmed for lunch, dinner, and special events, creating the perfect ambiance for each occasion.

Modular designs are another innovation addressing the need for flexible configurations. Modular LED panel lights can be combined and arranged in various patterns to create custom lighting solutions. This adaptability is particularly useful in commercial environments where lighting needs may change over time or vary across different areas of a building. For example, in an office, modular panels can be reconfigured to accommodate changes in layout or function, ensuring that each workspace is optimally lit. Similarly, in retail settings, modular panels can highlight different product displays or create distinct zones within a store.

The continued evolution of LED panel light technology is driven by the desire to provide more personalized and adaptable lighting solutions. As manufacturers respond to consumer demand, we can expect to see further advancements in features such as color rendering, energy efficiency, and user-friendly controls. Innovations like dynamic daylight simulation, which mimics natural light patterns to support human circadian rhythms, and integration with other smart building systems will enhance the functionality and appeal of LED panel lights. By meeting the diverse needs of users in various settings, LED panel lights are set to remain a versatile and essential component of modern lighting design.

The prevalence of light-emitting devices in modern life cannot be overstated. From residential homes to commercial establishments, public infrastructure to personal gadgets, lighting solutions play a critical role in our daily activities and overall well-being. With the widespread adoption of light devices, even a small advancement in their technology or design can lead to significant improvements and widespread impact. These improvements not only enhance the functionality and user experience but also contribute to energy efficiency, cost savings, and environmental sustainability.

Given the extensive use of lighting devices, continuous innovation in this field is crucial. A key area of focus is the flexibility of lighting solutions. Users increasingly demand lighting systems that can be tailored to their specific needs and preferences. This includes the ability to adjust brightness and color temperature, customize lighting scenes, and integrate with smart home systems. Flexible lighting solutions can enhance comfort, productivity, and mood, making them highly desirable in various settings such as homes, offices, and public spaces.

In addition to flexibility, the functional capabilities of lighting devices are paramount. Modern lighting systems are expected to do more than just illuminate a space. They should support various activities, improve safety and security, and contribute to aesthetic appeal. For instance, in commercial environments, lighting can enhance the shopping experience or increase productivity in the workplace. In public spaces, intelligent lighting systems can provide dynamic illumination that responds to environmental conditions and user movement, improving safety and energy efficiency.

Cost is another critical factor in the development of lighting technologies. As lighting devices are ubiquitous, cost-effective solutions can lead to substantial savings for consumers and businesses alike. Advances that reduce the manufacturing and operational costs of lighting systems without compromising performance are highly beneficial. This includes innovations in materials, production processes, and energy consumption. Lower costs can accelerate the adoption of advanced lighting technologies, making them accessible to a broader range of users and applications.

Robustness and durability are essential considerations for lighting devices, especially in demanding environments. Lighting systems must withstand various conditions, including fluctuations in temperature, humidity, and mechanical stress. Enhancing the robustness of lighting devices ensures their longevity and reliability, reducing maintenance costs and minimizing disruptions. This is particularly important for applications in industrial settings, outdoor lighting, and critical infrastructure where consistent performance is crucial.

Ultimately, the pursuit of innovation in lighting technology involves a holistic approach that considers multiple factors: flexibility, functionality, cost, and robustness. By addressing these aspects, new advancements can bring about substantial improvements in human life. Enhanced lighting solutions can provide better quality of life through improved comfort and aesthetics, greater efficiency through reduced energy consumption and costs, and increased safety and productivity. As such, ongoing research and development in this field are not only beneficial but essential to harnessing the full potential of lighting technology to meet the evolving needs of society.

### SUMMARY

In some embodiments, a lighting apparatus includes multiple LED modules, a light source plate, a driver circuit, a driver plate, a flexible flat cable, a bottom housing, a top housing and an Edison cap.

The multiple LED modules are disposed on a front side of the light source plate.

The driver circuit is disposed on the driver plate.

The flexible flat cable has a maximum length.

The flexible flat cable has a first end connected to the light source plate and has a second end connected to the driver plate.

The bottom housing is for disposing the driver plate.

The top housing encloses the light source plate and the multiple LED modules.

The top housing is manually operated to adjust a relative distance between the top housing and the bottom housing along a longitudinal direction to alter a total combined length in the longitudinal direction.

The Edison cap is coupled to the bottom housing for guiding an external power to the driver circuit to generate driving currents to the multiple LED modules via the flexible flat cable.

In some embodiments, the light source plate has a first set of connector pins for plugging to the first end of the flexible flat cable.

In some embodiments, the driver plate has a second set of connector pins for plugging to the second end of the flexible flat cable.

In some embodiments, when the total combined length in the longitudinal direction reaches a maximum value, the flexible flat cable is extended to a maximum allowable length.

In some embodiments, the flexible flat cable prevents an excessive movement between the top housing and the bottom housing.

In some embodiments, the top housing encases and slides over the bottom housing.

In some embodiments, the bottom housing encases and slides over the top housing.

In some embodiments, a first diameter of the top housing is larger than 3 times of a second diameter of the bottom housing.

The first diameter and the second diameter are measured perpendicular to the longitudinal direction.

In some embodiments, the lighting apparatus may also include a sliding track for the top housing to move with respect to the bottom housing.

In some embodiments, the top housing and the bottom housing are moved with a rotation manner to change the total longitudinal length.

In some embodiments, the lighting apparatus may also include a limiter for limit a maximum rotation angle between the top housing and the bottom housing.

In some embodiments, the total combined length determines an optical parameter of the multiple LED modules.

In some embodiments, the optical parameter includes a color temperature.

A first total combined length corresponds to a first color temperature.

A second total combined length corresponds to a second color temperature.

The first color temperature is different form the second color temperature.

In some embodiments, the lighting apparatus may also include a lens cover.

When the total longitudinal length is changed, a output light pattern is changed when a relative position between the lens cover and the multiple LED modules is changed.

In some embodiments, the lighting apparatus may also include a separating wall.

When the total longitudinal length is changed, a output light spanning angle is changed when a relative position between the separating wall and the multiple LED modules is changed.

In some embodiments, a data receiver disposed on the light source plate sends a signal to the driver circuit as a reference for the driver module to control the lighting apparatus.

In some embodiments, a control circuit is disposed on the flexible flat cable for providing a function to the driver circuit.

In some embodiments, the control circuit includes an identification indicating a parameter of the multiple LED modules.

In some embodiments, the driver circuit determines a parameter of the multiple LED modules to select one from multiple pressured control methods to control the multiple LED modules.

In some embodiments, the flexible flat cable is connected to a manual switch to receive a setting provided to the driver circuit as a reference to control the multiple LED modules.

### BRIEF DESCRIPTION OF DRAWINGS

FIG. 1 illustrates a perspective view of a lighting apparatus embodiment.

FIG. 2 illustrates an exploded view of the example in FIG. 1.

FIG. 3 illustrates a cross-sectional view of the example in FIG. 1.

FIG. 4 illustrates a bottom housing example.

FIG. 5 illustrates a top housing example.

FIG. 6 illustrates a zoom-up view of a connection part.

FIG. 7 illustrates a zoom-up view of another connection part.

FIG. 8 illustrates another lighting apparatus.

FIGS. 9A and 9B illustrate two operation statuses.

FIGS. 10A and 10B show another lighting apparatus embodiment.

FIG. 11 shows another lighting apparatus embodiment.

### DETAILED DESCRIPTION

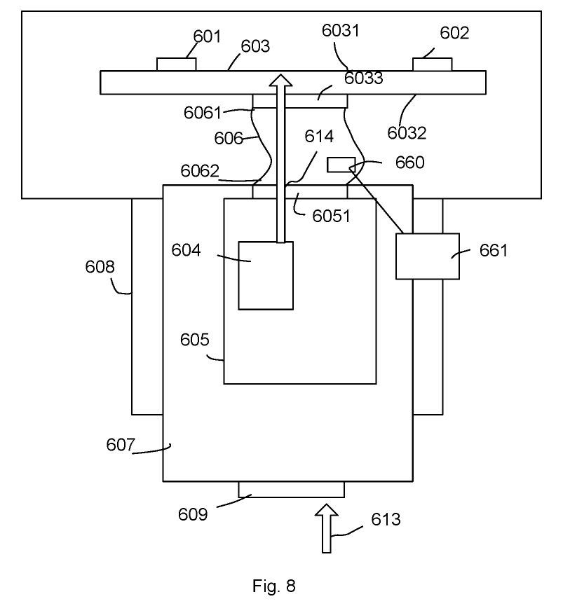

In FIG. 8, a lighting apparatus includes multiple LED modules 601, 602, a light source plate 603, a driver circuit 604, a driver plate 605, a flexible flat cable 606, a bottom housing 607, a top housing 608 and an Edison cap 609.

The multiple LED modules 601, 602 are disposed on a front side 6031 of the light source plate 603.

The driver circuit 604 is disposed on the driver plate 605.

The flexible flat cable 606 has a maximum length, which is the length when the flexible flat cable 606 is stretched its maximum in a longitudinal direction from two ends of the flexible flat cable 606 for connecting two components.

The flexible flat cable 606 has at first end 6061 connected to the light source plate 603 and has a second end 6062 connected to the driver plate 603.

The bottom housing 607 is for disposing the driver plate 605.

The top housing 608 encloses the light source plate 603 and the multiple LED modules 601, 602.

The top housing 608 is manually operated to adjust a relative distance between the top housing and the bottom housing along a longitudinal direction to alter a total combined length in the longitudinal direction.

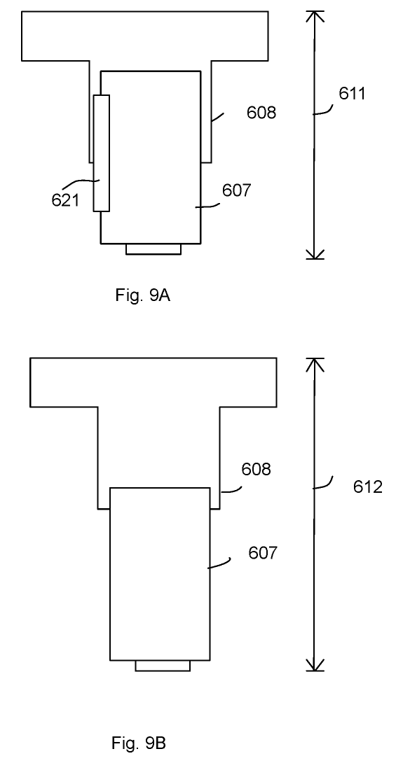

FIGS. 9A and 9B show an operation statuses by adjusting the relative distance between the top housing 608 and the bottom housing 607 to alter a total combined length 611 to 612.

In FIG. 8, the Edison cap 609 is coupled to the bottom housing 607 for guiding an external power to the driver circuit 604 to generate driving currents 614 to the multiple LED modules 601, 602 via the flexible flat cable 606.

In some embodiments, the light source plate 603 has a first set of connector pins 6033 for plugging to the first end 6061 of the flexible flat cable 606.

In some embodiments, the driver plate 605 has a second set of connector pins 6051 for plugging to the second end 6062 of the flexible flat cable 606.

In some embodiments, when the total combined length in the longitudinal direction reaches a maximum value, the flexible flat cable is extended to a maximum allowable length.

FIGS. 9A and 9B show two different total combined lengths. Because two ends of the flexible flex cable are respectively connected to the top housing and the bottom housing, when the top housing is move away from the bottom housing, the flexible flex cable is stretched. When the flexible flex cable is stretched to its maximum, it provides a limit for further moving the top housing away from the bottom housing.

In some embodiments, the flexible flat cable prevents an excessive movement between the top housing and the bottom housing.

In some embodiments, the top housing encases and slides over the bottom housing.

In some embodiments, the bottom housing encases and slides over the top housing.

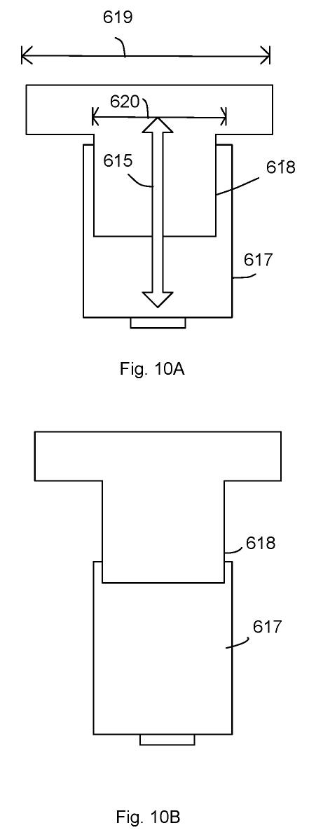

FIGS. 10A and 10B show another example compared with FIGS. 9A and 9B.

In FIG. 9A, the top housing 608 has a larger diameter in the connection part than the bottom housing 607. In the example of FIG. 9A, the top housing 608 encases and slides over the bottom housing 607.

In FIG. 10A, the top housing 618 has smaller diameter in the connection part than the bottom housing 617. In this example, the bottom housing 618 encases and slides over the top housing 618 along the longitudinal direction 615.

In FIG. 10A, a first diameter 619 of the top housing 618 is larger than 3 times of a second diameter 620 of the bottom housing 618.

The first diameter 619 and the second diameter 620 are measured perpendicular to the longitudinal direction 615.

In FIG. 9A, the lighting apparatus may also include a sliding track 621 for the top housing 608 to move with respect to the bottom housing 607.

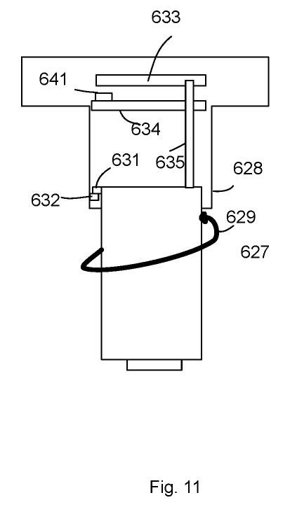

In FIG. 11, the top housing 628 and the bottom housing 627 are moved with a rotation manner, e.g. along the rotation line 627 with a screw groove, to change the total longitudinal length.

In some embodiments, the lighting apparatus may also include a limiter for limit a maximum rotation angle between the top housing and the bottom housing.

FIG. 11 shows such a limiter which has a first part 631 disposed in the top housing 628 and a second part 632 disposed in the bottom housing 627. When the relative movement between the top housing 628 and the bottom housing 627 reaches its limit, the limiter restrict a further movement.

In some embodiments, the total combined length determines an optical parameter of the multiple LED modules.

For example, the driver circuit is coupled to a sensor, e.g. to detect a resistor value that varies in response to the total combined length, to determine a corresponding parameter to control the output of the multiple LED modules.

In some embodiments, the optical parameter includes a color temperature.

A first total combined length corresponds to a first color temperature.

A second total combined length corresponds to a second color temperature.

The first color temperature is different form the second color temperature.

In some embodiments, the lighting apparatus may also include a lens cover.

When the total longitudinal length is changed, a output light pattern is changed when a relative position between the lens cover and the multiple LED modules is changed.

FIG. 11 shows a lens cover 633 that is connected to the bottom housing with a lever 635. When the bottom housing 627 is moved with respect to the top housing 628, the lens cover 633 is moved with respect to the light source plate 634 that is mounted with LED modules. By changing the relative distance between the lens cover 633 and the LED modules, its light pattern is adjusted depending different types of lens.

In some embodiments, the lighting apparatus may also include a separating wall.

The position of the lens 633 may be disposed with separating wall that opens a window. When the separating wall is moved with respect to the light source plate 634, its output light pattern, e.g. the spanning angle of output light is adjusted.

When the total longitudinal length is changed, a output light spanning angle is changed when a relative position between the separating wall and the multiple LED modules is changed.

In FIG. 11, a data receiver 641, e.g. an antenna or a sensor, disposed on the light source plate 634 sends a signal to the driver circuit as a reference for the driver circuit to control the lighting apparatus.

In FIG. 8, a control circuit 660 is disposed on the flexible flat cable 606 for providing a function to the driver circuit 604.

In some embodiments, the control circuit includes an identification, e.g. data of the LED module type or configuration, indicating a parameter of the multiple LED modules.

In some embodiments, the driver circuit determines a parameter of the multiple LED modules to select one from multiple pressured control methods to control the multiple LED modules.

In some embodiments, the flexible flat cable is connected to a manual switch 661 to receive a setting provided to the driver circuit as a reference to control the multiple LED modules.

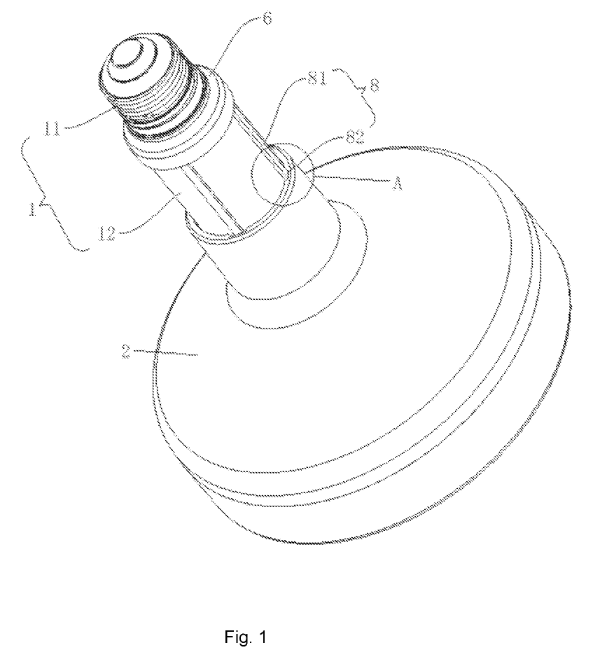

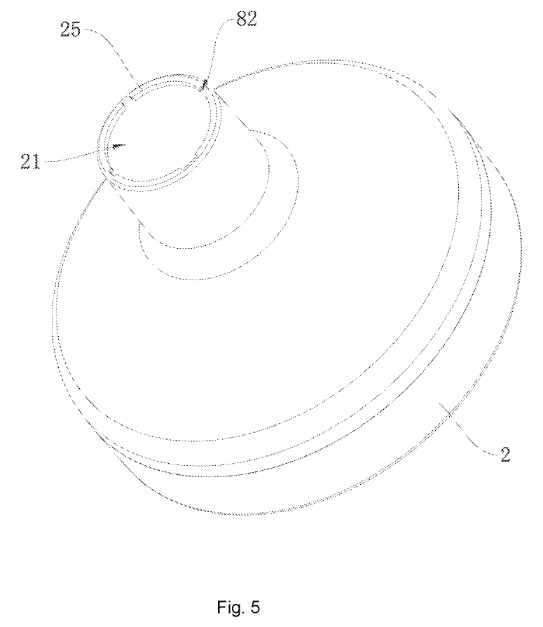

Please refer to FIGS. 1-7. In the embodiment of the present utility model, a lamp is provided, which includes a lamp holder assembly 1 and a movable assembly 2 slidably connected to the lamp holder assembly 1. A driving assembly 5 is arranged inside the lamp holder assembly 1, which is used for electrical connection with an external power supply. A light source assembly 3 for illumination is arranged inside the movable assembly 2, and the light source assembly 3 is electrically connected to the driving assembly 5 through a flexible connector 4.

The lamp holder assembly 1 refers to the component used to install the lamp into the socket. At least a part of the lamp holder assembly 1 is made of conductive material. The electrical components inside the lamp can be directly connected to or in contact with the conductive part. The function of the lamp holder assembly 1 is to install and fix the lamp in the socket and communicate with the socket through the conductive part, thereby finally realizing the connection between the internal electrical components of the lamp and the external circuit.

The light source assembly 3 refers to a component that can convert electrical energy into light energy. The light source assembly 3 can be any of a bulb, filament, or LED lamp beads set on the light source board. The driving assembly 5 refers to the electrical component used to convert the voltage and/or current of the external circuit into a form suitable for the light source assembly 3. The light source assembly 3 needs to maintain electrical connection with the driving assembly 5. The flexible connector 4 refers to a conductive component with a certain degree of flexibility, which can be any of a wire, flat cable, or other flexible conductors that can be bent repeatedly.

The movable assembly 2 refers to the part of the lamp that can slide relative to the lamp holder assembly 1. The movable assembly 2 can include part or all of the lamp housing and the illumination components set inside the housing.

In the lamp provided by the embodiment of the present utility model, the movable assembly 2 is slidably connected with the lamp holder assembly 1. The relative position between the movable assembly 2 and the lamp holder assembly 1 can be adjusted according to the depth of the lamp tube, thereby adjusting the overall length of the lamp, making the lamp adaptable to different specifications of lamp tubes. Meanwhile, a driving assembly 5 is arranged inside the lamp holder assembly 1, and a light source assembly 3 for illumination is arranged inside the movable assembly 2. The light source assembly 3 is connected to the driving assembly 5 through a flexible connector 4. When the relative position between the movable assembly 2 and the lamp holder assembly 1 changes, the light source assembly 3 and the driving assembly 5 remain connected solely through the bending of the flexible connector 4. Compared to the prior art where a sliding connection with conductive shrapnel is used, this avoids problems such as unstable connections and increased conduction loss caused by loosening, wear, or oxidation of the conductive shrapnel after prolonged use of the lamp. It ensures the stability of the connection between the light source assembly 3 and the driving assembly 5 even after long-term use, thus extending the lamp's service life. Additionally, the lamp structure becomes simpler, and the production cost of the lamp is reduced.

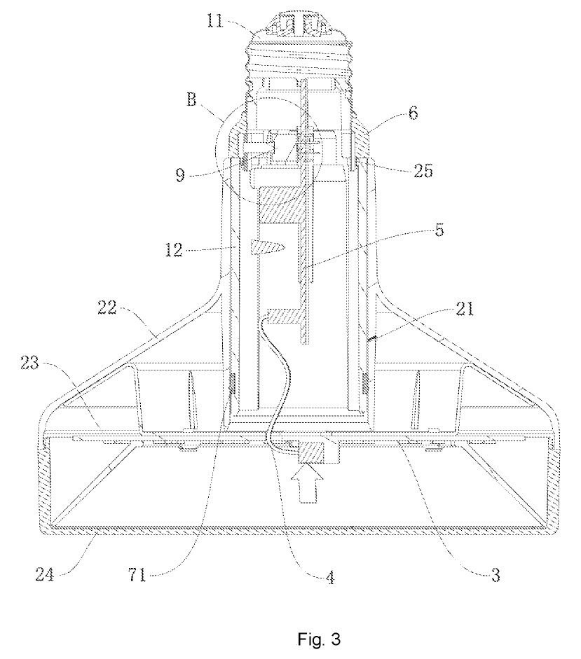

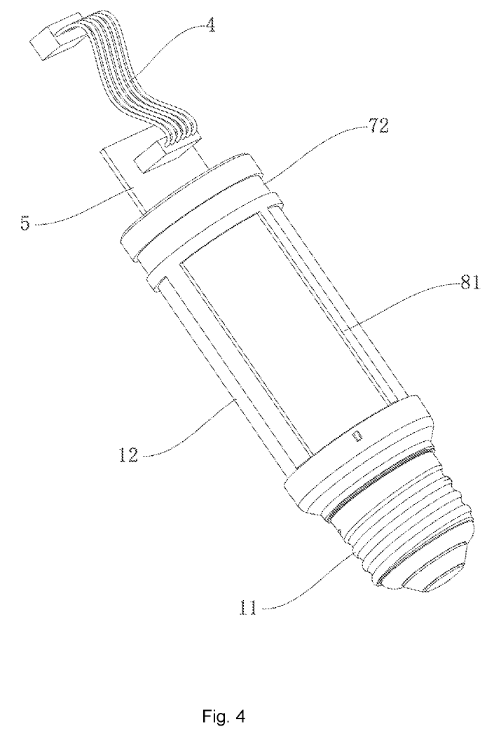

In one embodiment, as shown in FIGS. 3 and 4, the flexible connector 4 includes a flexible flat cable. One end of the flexible flat cable is connected to the light source assembly 3, and the other end of the flexible connector 4 is connected to the driving assembly 5. Specifically, the flexible flat cable refers to a set of wires with a certain degree of softness arranged side by side, with connectors set at both ends of the wires. When connecting the driving assembly 5 and the light source assembly 3, the connectors can be respectively plugged into the terminals set on the driving circuit board or the light source board, making the connection between the driving assembly 5 and the light source assembly 3 more convenient and stable. The structure is simple, easy to replace, and significantly reduces the production cost of the lamp.

In one embodiment, as shown in FIGS. 1-4, the lamp holder assembly 1 includes a telescopic connecting member 12 and a lamp holder 11 set on the telescopic connecting member 12. The telescopic connecting member 12 is a hollow structure with the driving assembly 5 set inside and electrically connected to the lamp holder 11. A sliding channel 21 is set on the movable assembly 2, and at least a part of the telescopic connecting member 12 is slidably set inside the sliding channel 21. Specifically, the lamp holder 11 refers to a cap with an external thread. The lamp holder 11 can be made of conductive material and/or additional conductive materials can be set on the lamp holder 11 to connect with the driving assembly 5, such as components like thumbtacks. The telescopic connecting member 12 refers to a columnar component with a certain length, and the interior of the telescopic connecting member 12 is hollow to accommodate the driving assembly 5. To facilitate the connection between the driving assembly 5 and the conductive parts on the lamp holder assembly 1, both ends of the telescopic connecting member 12 can be open structures. The driving assembly 5 connects with the lamp holder assembly 1 through the opening at one end of the telescopic connecting member 12, and connects with the light source assembly 3 through the opening at the other end. The sliding channel 21 refers to a hole with a certain depth dimension on the movable assembly 2, which is used to accommodate the telescopic connecting member 12. The sliding channel 21 can have an opening at one end, or openings at both ends.

At least a part of the telescopic connecting member 12 extends into the interior of the sliding channel 21 through the opening, and is slidably set inside the sliding channel 21, thereby achieving the sliding connection between the lamp holder assembly 1 and the movable assembly 2. When the position of the movable assembly 2 needs to be adjusted, the movable assembly 2 can be pulled along the length direction of the telescopic connecting member 12, making the position adjustment of the movable assembly 2 more convenient and simple.

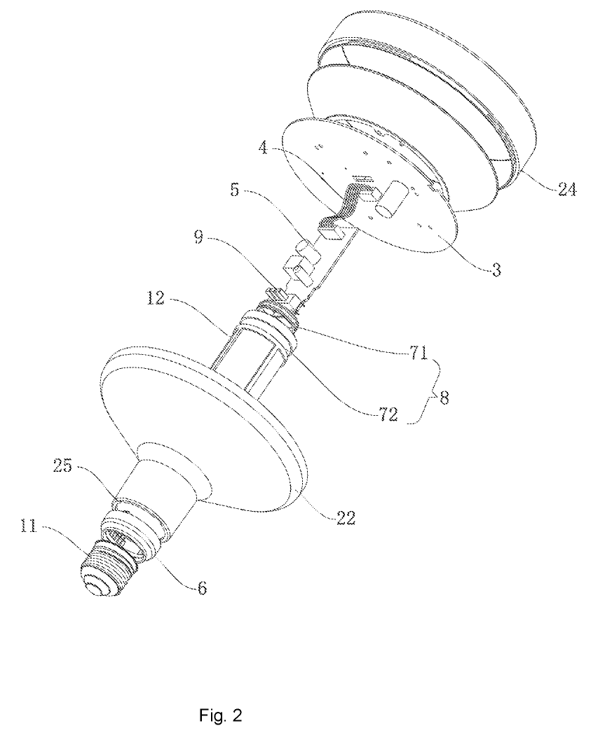

In a specific embodiment, as shown in FIGS. 2 and 3, the telescopic connecting member 12 is a cylindrical body with openings at both ends. Specifically, the lamp holder 11 is set at one end of the telescopic connecting member 12, and the driving assembly 5 is arranged inside the telescopic connecting member 12. The telescopic connecting member 12, being a cylindrical body, provides space for the installation of the driving assembly 5 while making the telescopic connecting member 12 lighter and stronger, thereby reducing the cost of the lamp.

In an alternative embodiment, as shown in FIG. 2, the movable assembly 2 includes a heat dissipation cylindrical part 22, a heat dissipation disk 23 set inside the heat dissipation cylindrical part 22, a light source assembly 3 set on the heat dissipation disk 23, and a light-transmitting cover 24 covering the first end of the heat dissipation part. Specifically, the first end of the heat dissipation cylindrical part 22 is flared, and the second end of the heat dissipation cylindrical part 22 is sleeved on the outside of the telescopic connecting member 12. The telescopic connecting member 12 is slidably arranged inside the heat dissipation cylindrical part 22. The heat dissipation disk 23 and the light source assembly 3 are positioned at the flared end of the heat dissipation cylindrical part 22, and the light-transmitting cover 24 covers the first end of the heat dissipation cylindrical part 22.

Based on the above features of the movable assembly 2, as shown in FIG. 2, the light source assembly 3 can include a main light source and a night light source. A partition is also arranged inside the movable assembly 2, with the main light source and the night light source respectively set on the inner and outer sides of the partition, enabling the lamp to have multiple lighting functions.

In one embodiment, as shown in FIGS. 2 and 3, a damping structure 7 is further arranged between the outer wall of the telescopic connecting member 12 and the inner wall of the sliding channel 21. The telescopic connecting member 12 makes damping contact with the sliding channel 21 through the damping structure 7. Specifically, the damping structure 7 refers to components that can keep the movable assembly 2 relatively stationary with respect to the telescopic connecting member 12 when no external pulling or pushing force is applied to the movable assembly 2. Under the action of the damping structure 7, the sliding speed of the telescopic connecting member 12 in the sliding channel 21 can be controlled to avoid poor adjustment precision caused by too fast a sliding speed. Additionally, after the position of the movable assembly 2 is adjusted to a specified position, the damping structure 7 can fix the movable assembly 2 in place, preventing it from continuing to slide.

In a specific embodiment, as shown in FIGS. 2 and 3, the damping structure 7 includes an elastic ring 71. The elastic ring 71 is sleeved on the outside of the telescopic connecting member 12, with the outer ring of the elastic ring 71 frictionally contacting the inner wall of the sliding channel 21. Specifically, the elastic ring 71 is an annular component with certain elasticity, which can be made of silicone, rubber, or other elastic materials. The elastic ring 71 is sleeved on the outside of the telescopic connecting member 12, which is then inserted into the sliding channel 21. The outer ring of the elastic ring 71 presses against the inner wall of the sliding channel 21. When the position of the movable assembly 2 needs to be adjusted, pulling the movable assembly 2 with a force greater than the friction between the outer ring of the elastic ring 71 and the inner wall of the sliding channel 21 enables the relative movement between the movable assembly 2 and the telescopic connecting member 12, achieving stepless adjustment of the telescopic connecting member 12 within the sliding channel 21. After adjusting the position of the movable assembly 2, the friction between the outer ring of the elastic ring 71 and the inner wall of the sliding channel 21 fixes the telescopic connecting member 12 and the movable assembly 2 relative to each other.

In an optional embodiment, the number of elastic rings 71 can be multiple, arranged at intervals along the length of the telescopic connecting member 12, enhancing the positioning effect of the damping structure 7.

In one embodiment, as shown in FIGS. 2 and 3, the telescopic connecting member 12 is provided with a limiting groove 72 for accommodating the elastic ring 71. The limiting groove 72 is arranged circumferentially along the telescopic connecting member 12. Specifically, the limiting groove 72 is an annular groove set on the outer wall of the telescopic connecting member 12. The limiting groove 72 can be directly recessed into the outer wall of the telescopic connecting member 12 or formed by two annular protrusions set at intervals on the outer wall of the telescopic connecting member 12, with the gap between them being the limiting groove 72. The setting of the limiting groove 72 can prevent the elastic ring 71 from sliding along the length direction of the telescopic connecting member 12 to a certain extent, making the installation of the elastic ring 71 more stable.

In an optional embodiment, the movable assembly 2 is also provided with a fixing component for fixing the telescopic connecting member 12 and the movable assembly 2 to each other. After the movable assembly 2 slides to a suitable position along the telescopic connecting member 12, the fixing component can fix the movable assembly 2 and the telescopic connecting member 12. The fixing component can be a threaded rod, at least partially located inside the sliding channel 21 and threadedly connected with the movable assembly 2. The threaded rod can be moved by rotating it. When the telescopic connecting member 12 and the movable assembly 2 need to be fixed, the threaded rod can be rotated to bring it close to and abut against the telescopic connecting member 12, thereby achieving fixation. When fixation is not needed, the threaded rod can be rotated in the opposite direction to move it away from the telescopic connecting member 12, allowing free sliding of the two components.

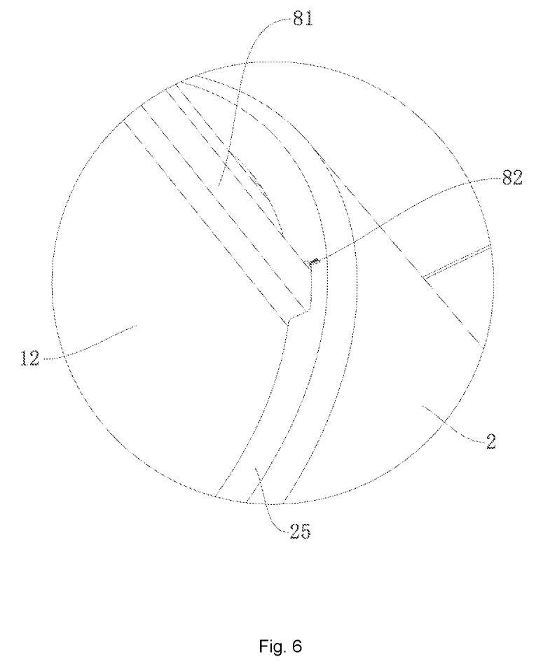

In one embodiment, as shown in FIGS. 1 and 6, an anti-rotation structure 8 is arranged between the telescopic connecting member 12 and the inner wall of the sliding channel 21 to prevent the telescopic connecting member 12 from rotating. Specifically, the anti-rotation structure 8 can be a protrusion set on the surface of the telescopic connecting member 12 and a sliding groove set on the inner wall of the sliding channel 21, running axially along the sliding channel 21. By sliding the protrusion in the sliding groove, the telescopic connecting member 12 can only slide along the length direction of the sliding groove. The anti-rotation structure 8 can also be an anti-rotation rod set at the end of the telescopic connecting member 12, with the anti-rotation rod arranged axially along the sliding channel 21 and having a polygonal cross-section. The movable assembly 2 is provided with an anti-rotation hole matching the shape of the anti-rotation rod. When the telescopic connecting member 12 is inside the sliding channel 21, the anti-rotation rod is inserted into the anti-rotation hole, restricting the telescopic connecting member 12 to axial sliding only. The anti-rotation structure 8 prevents the telescopic connecting member 12 from rotating during sliding in the sliding channel 21, thereby avoiding the risk of the flexible connector 4 being excessively twisted and damaged, making the lamp safer to use.

In one embodiment, as shown in FIGS. 1 and 6, the anti-rotation structure 8 includes multiple first guiding parts 81 set on the telescopic connecting member 12 and second guiding parts 82 set on the inner wall of the sliding channel 21, with the positions of the first and second guiding parts matching each other. The first guiding parts 81 and the second guiding parts 82 are in sliding fit and are arranged axially along the telescopic connecting member 12. Specifically, the first guiding part 81 refers to a guiding structure set on the outer wall of the telescopic connecting member 12, which can be a rib arranged along the sliding direction of the telescopic connecting member 12, or a sliding groove arranged along the sliding direction of the telescopic connecting member 12, with at least one end of the sliding groove being open. The second guiding part 82 refers to a guiding structure set on the inner wall of the sliding channel 21, which can be a sliding groove arranged along the sliding direction of the telescopic connecting member 12, with at least one end of the sliding groove being open, or a rib arranged along the sliding direction of the telescopic connecting member 12. When the telescopic connecting member 12 is installed inside the sliding channel 21, the rib can be inserted into the sliding groove, ensuring that the telescopic connecting member 12 can only slide along the length direction of the sliding groove and preventing rotation.

In an optional embodiment, as shown in FIGS. 1, 5, and 6, a limiting ring 25 is also arranged at the opening of the sliding channel 21 to prevent the telescopic connecting member 12 from coming out of the sliding channel 21. Specifically, the limiting ring 25 is coaxially arranged with the sliding channel 21, and the inner diameter of the limiting ring 25 is smaller than that of the sliding channel 21. A limiting rib matching the limiting ring 25 is also set on the telescopic connecting member 12, with the diameter of the limiting rib being greater than the inner diameter of the limiting ring 25. When the limiting rib slides to the opening of the sliding channel 21, the limiting ring 25 blocks the limiting rib, thus preventing the telescopic connecting member 12 from coming out of the sliding channel 21 to a certain extent.

Based on the above characteristics of the limiting ring 25, as shown in FIGS. 4-6, the first guiding part 81 is a rib set on the telescopic connecting member 12 and arranged along the sliding direction of the telescopic connecting member 12, and the second guiding part 82 is a sliding groove set on the inner wall of the limiting ring 25. Since the thickness of the limiting ring 25 is relatively thin, setting the sliding groove on the limiting ring 25 can reduce production difficulty and cost while making the installation of the telescopic connecting member 12 more convenient and quicker.

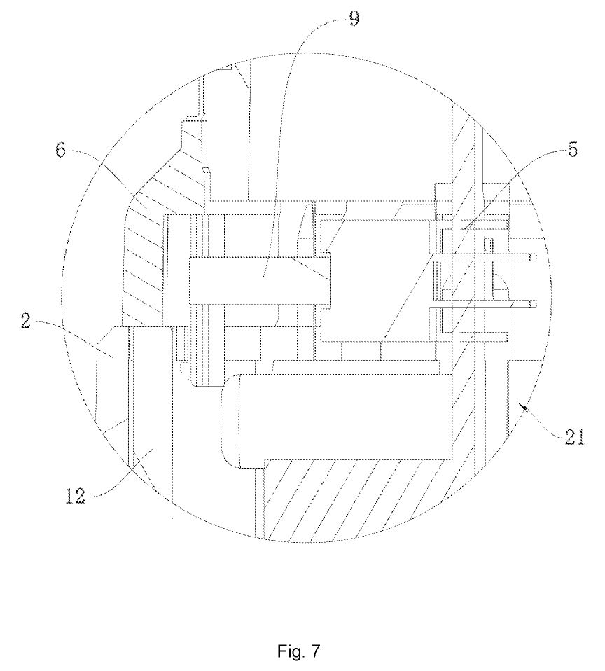

In one embodiment, as shown in FIGS. 3 and 7 the driving assembly 5 is provided with an adjustment circuit for adjusting the light source assembly 3. An adjustment switch 9 electrically connected to the adjustment circuit is set inside the telescopic connecting member 12, and an adjustment component 6 for driving the adjustment end of the adjustment switch 9 to move is movably arranged on the telescopic connecting member 12. Specifically, the adjustment switch 9 refers to an electrical component connected to the adjustment circuit on the driving assembly 5 for adjusting the color temperature or power of the light source assembly 3. The adjustment switch 9 can be any of a dip switch, a travel encoder, or other adjustment switches. The adjustment component 6 refers to a solid component that is movably arranged on the telescopic connecting member 12, meaning that the adjustment component 6 can move relative to the telescopic connecting member 12. The movement can be along the length direction of the telescopic connecting member 12 or rotational around the axis of the telescopic connecting member 12. The adjustment component 6 is connected to the adjustment end of the adjustment switch 9. By moving the adjustment component 6, the adjustment end of the adjustment switch 9 is driven to move, thereby achieving the adjustment function of the adjustment switch 9.

In a specific embodiment, as shown in FIG. 3, the adjustment component 6 is a rotating adjustment ring sleeved on the telescopic connecting member 12, with the adjustment end connected to the inner wall of the rotating adjustment ring. Specifically, the rotating adjustment ring is sleeved on the outside of the telescopic connecting member 12. By rotating the adjustment ring, the adjustment of the adjustment switch 9 can be achieved, saving installation space for the adjustment component 6 and making the lamp's appearance more aesthetically pleasing.

In an optional embodiment, as shown in FIGS. 3 and 7, a receiving slot for accommodating the adjustment end of the adjustment switch 9 is set on the inner wall of the rotating adjustment ring, with at least part of the adjustment end located inside the receiving slot. The adjustment end of the adjustment switch 9 extends into the receiving slot through a clearance hole set on the side wall of the telescopic connecting member 12. When the rotating adjustment ring rotates, the two side walls of the receiving slot can push the adjustment end of the adjustment switch 9 to move, making the connection between the adjustment end and the rotating adjustment ring more convenient.

In one embodiment, as shown in FIG. 3, an elastic protrusion is set on the outer wall of the telescopic connecting member 12, and multiple positioning grooves matching the elastic protrusion are set on the inner wall of the rotating adjustment ring. The positioning grooves are arranged at intervals along the circumference of the telescopic connecting member 12. Specifically, the positioning grooves refer to recessed areas set on the inner wall of the rotating adjustment ring. The elastic protrusion refers to a component set on the outer wall of the telescopic connecting member 12 with certain elasticity in its height direction. The elastic protrusion can be integrally formed with the telescopic connecting member 12 or an additional component set on the outside of the telescopic connecting member 12. When the rotating adjustment ring rotates, the elastic protrusion can successively engage in different positioning grooves, serving as a position indicator, making the adjustment of the rotating adjustment ring more convenient.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
multiple LED modules;
a light source plate, wherein the multiple LED modules are disposed on a front side of the light source plate;
a driver circuit;
a driver plate, wherein the driver circuit is disposed on the driver plate;
a flexible flat cable with a maximum length, wherein the flexible flat cable has a first end connected to the light source plate and has a second end connected to the driver plate;
a bottom housing for disposing the driver plate;
a top housing for enclosing the light source plate and the multiple LED modules, wherein the top housing is manually operated to adjust a relative distance between the top housing and the bottom housing along a longitudinal direction to alter a total combined length in the longitudinal direction; and
an Edison cap coupled to the bottom housing for guiding an external power to the driver circuit to generate driving currents to the multiple LED modules via the flexible flat cable.

2. The lighting apparatus of claim 1, wherein the light source plate has a first set of connector pins for plugging to the first end of the flexible flat cable.

3. The lighting apparatus of claim 2, wherein the driver plate has a second set of connector pins for plugging to the second end of the flexible flat cable.

4. The lighting apparatus of claim 1, wherein when the total combined length in the longitudinal direction reaches a maximum value, the flexible flat cable is extended to a maximum allowable length.

5. The lighting apparatus of claim 4, wherein the flexible flat cable prevents an excessive movement between the top housing and the bottom housing.

6. The lighting apparatus of claim 1, wherein the top housing encases and slides over the bottom housing.

7. The lighting apparatus of claim 1, wherein the bottom housing encases and slides over the top housing.

8. The lighting apparatus of claim 1, wherein a first diameter of the top housing is larger than 3 times of a second diameter of the bottom housing, wherein the first diameter and the second diameter are measured perpendicular to the longitudinal direction.

9. The lighting apparatus of claim 1, further comprising a sliding track for the top housing to move with respect to the bottom housing.

10. The lighting apparatus of claim 1, wherein the top housing and the bottom housing are moved with a rotation manner to change the total longitudinal length.

11. The lighting apparatus of claim 10, further comprising a limiter for limit a maximum rotation angle between the top housing and the bottom housing.

12. The lighting apparatus of claim 1, wherein the total combined length determines an optical parameter of the multiple LED modules.

13. The lighting apparatus of claim 12, wherein the optical parameter comprises a color temperature, wherein a first total combined length corresponds to a first color temperature, wherein a second total combined length corresponds to a second color temperature, wherein the first color temperature is different form the second color temperature.

14. The lighting apparatus of claim 1, further comprising a lens cover, wherein when the total longitudinal length is changed, a output light pattern is changed when a relative position between the lens cover and the multiple LED modules is changed.

15. The lighting apparatus of claim 1, further comprising a separating wall, wherein when the total longitudinal length is changed, a output light spanning angle is changed when a relative position between the separating wall and the multiple LED modules is changed.

16. The lighting apparatus of claim 1, wherein a data receiver disposed on the light source plate sends a signal to the driver circuit as a reference for the driver module to control the lighting apparatus.

17. The lighting apparatus of claim 1, wherein a control circuit is disposed on the flexible flat cable for providing a function to the driver circuit.

18. The lighting apparatus of claim 17, wherein the control circuit comprises an identification indicating a parameter of the multiple LED modules.

19. The lighting apparatus of claim 17, wherein the driver circuit determines a parameter of the multiple LED modules to select one from multiple pressured control methods to control the multiple LED modules.

20. The lighting apparatus of claim 1, wherein the flexible flat cable is connected to a manual switch to receive a setting provided to the driver circuit as a reference to control the multiple LED modules.
